(19) United States
(12) Patent Application Publication
(10) Pub. No.: US 2006/0262519 A1
(43) Pub. Date: Nov. 23, 2006

(54) Power tool with work field illumination

(76) Inventors: Wolfgang Hirschburger, Thurston (GB); Sven Kageler, Leinfelden-Echterdingen (DE); Sim Teik Yeoh, Butterworth (MY)

Correspondence Address: STRIKER, STRIKER & STENBY, 103 EAST NECK ROAD, HUNTINGTON, NY, 11743, US

(21) Appl. No.: 11/416,151

(22) Filed: May 2, 2006

(30) Foreign Application Priority Data
May 4, 2005 (DE) 10 2005 021 383.9

(51) Int. Cl. B25B 23/18

(52) U.S. Cl. 362/119

(57) ABSTRACT

A power tool, in particular a cordless power tool, having a housing from which a tool emerges, with which tool a lighting device for a work field is associated, is made convenient to use because an LED serves as a light source, downstream of which is an optical light guide system, particularly with curved end faces, that collects the light from the LED and conducts it and aims it at a work field, and the LED and the light guide system are located in a light tube on the housing.

### CROSS-REFERENCE TO A RELATED APPLICATION

The invention described and claimed hereinbelow is also described in German patent application DE 1.02005 021383.9 filed on May 4, 2005. This German patent application, whose subject matter is incorporated here by reference, provides the basis for a claim of priority of invention under 35 U.SC. 119(a)-(d).

### BACKGROUND OF THE INVENTION

The present invention is based on a power tool.

Power tools that have simple work field illumination that is either fixedly set or complicatedly adjustable are known. One disadvantage of fixedly set work field illumination systems is that the beam of the lighting means is aimed only relatively imprecisely at the working tip of the tool.

### SUMMARY OF THE INVENTION

It is therefore an object of the present invention to provide a power tool with a work field illumination, which is a further improvement of the existing power tools.

According to the invention, the power tool does not have multiple optical lenses but instead a one-piece compact light guide system, which is simple to manufacture and which in conjunction with an LED with a high light yield assures that the focused beam is projected toward the front lens and onward toward the work field.

The light guide system is convex on its rearward end, where it forms a rear lens. The thickness of the convex rear lens is markedly greater than its diameter, so that it forms an elongated cylinder. This cylinder merges at its front end with a convex front lens of larger diameter. Over the length of the cylinder, the rear lens conducts the light, focused parallel, to the front lens, which protrudes in mushroomlike fashion radially past the cylinder. A compact, sturdy and economical optical system is thus created, with which precise illumination of the work field with a target-seeking function is possible, so that the drill tip or screwdriver bit tip can be brought especially quickly and precisely to the working point of the drilled hole or the screwdriving location.

The larger diameter of the oval front lens is approximately twice that of the circular rear lens, so that the illumination of the work field is therefore accomplished with an especially clearly contoured, concentrated beam of light.

The light guide system with its rear lens—jointly with an LED serving as a light source—is located so as to be protected from the outside against impacts or jarring, in an extremely compact arrangement in the interior of a light tube in the housing of the power tool.

The light tube, extending parallel to the axis of the driven shaft on the gearbox, is distinguishable on the outside thereof as a tubular contour and serves to reinforce the gearbox. The gearbox can be manufactured inexpensively, since as a cast part it can easily be unmolded from the casting mold jointly with the integrated light tube.

The rear lens, located at a defined spacing from the LED, collects virtually all the light emitted by the LED and carries it, inside the cylindrical part, known as a light conduit, of the light guide system, parallel as far as the convex, large-area front lens that is inclined toward the front. As a result, the light yield in the light guide system is especially high.

Because of the inclination of the front lens toward the front, the light emerges from the front lens aimed in a defined way obliquely upward and outward toward the work field and assures an especially sharply concentrated, bright beam of light.

A plastic piece holds the LED and, as a spacer or base, keeps it at the calculated spacing from the rear lens in the light tube positionally correctly and in a self-clamping way, and in particular fixed against relative rotation, so that no further fastening elements are needed for the LED.

The light tube extends parallel to and below the work spindle of the power tool. It protrudes past the front lens at the front and guards the front lens with its edge against damage from striking things as the power tool is manipulated and worked with.

The shape and dimensions of the light guide system, and especially the front lens, determine the projection length and the direction of the beam of light, and the light emerging from the front lens assures uniform-quality illumination of the work field over a relatively wide, variable range of spacing from the work field—that is, regardless of the length of the screwdriving or drill bit.

The focal point is located approximately 12 to 13 mm in front of the face end of the gearbox, for the sake of brilliant illumination of the work field, which is typically located approximately 30 to 100 mm in front of the end of the driven shaft. Because of this position of the focal point, the beam of light is “constricted” and is maximally deflected upward, without intersecting the contour of the gearbox.

The LED base can be fixed in the interior of the light tube in the manner of a stopper or by force-locking, so that the position of the LED in the light tube relative to the light guide system can be defined precisely.

The inner diameter of the light tube tapers conically over its length—in the self-inhibition region—and as a result fixes the base with the LED and the light guide system especially securely. These elements can also be positionally secured in the light tube by adhesive or by form-locking securing.

Because the light guide system is in one piece of glass-clear plastic with a scratchproof rear lens and front lens, its length being approximately 8 mm, the diameter of the cylinder being approximately 4 mm, and the larger diameter of the front lens being approximately 6 to 7 mm, and extends in the perpendicular center plane of the power tool, a highly effective, easily manufactured and easily installed optical system for improved illumination of the work field is created.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a side view of the power tool of the invention;

FIG. 2 shows a side view of the gearbox of the power tool of the invention;

FIG. 3 is a three-dimensional side view of the gearbox, with the lighting device of the power tool of the invention shown in exploded form;

FIG. 4 is an X-ray view of the power tool of the invention;

FIG. 5 is an enlarged detail of the lighting device of FIG. 4;

FIG. 6 is a schematic illustration of the lighting device;

FIG. 7 is a side view of the optical light guide system with the beam path; and

FIG. 8 is an enlarged side view of the light guide system of FIG. 7.

### DESCRIPTION OF THE PREFERRED EMBODIMENT

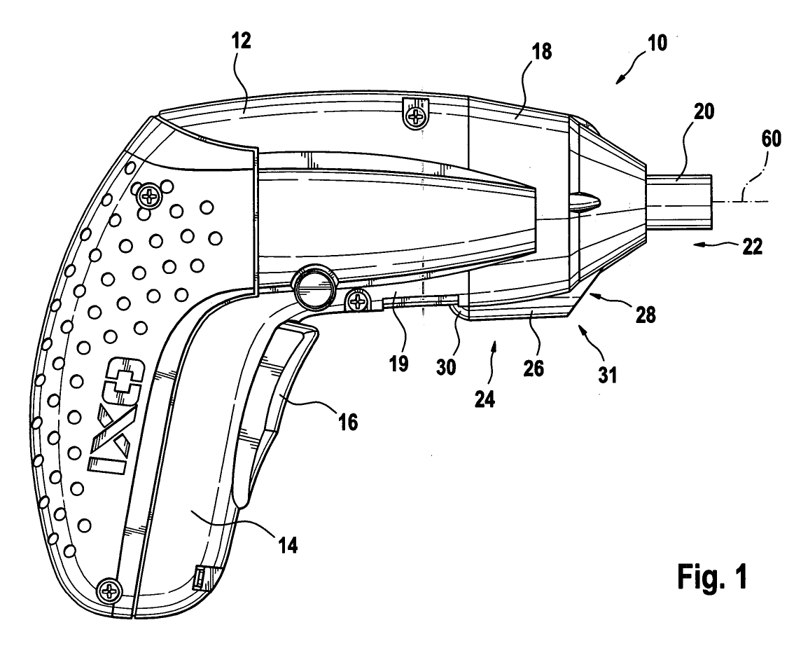

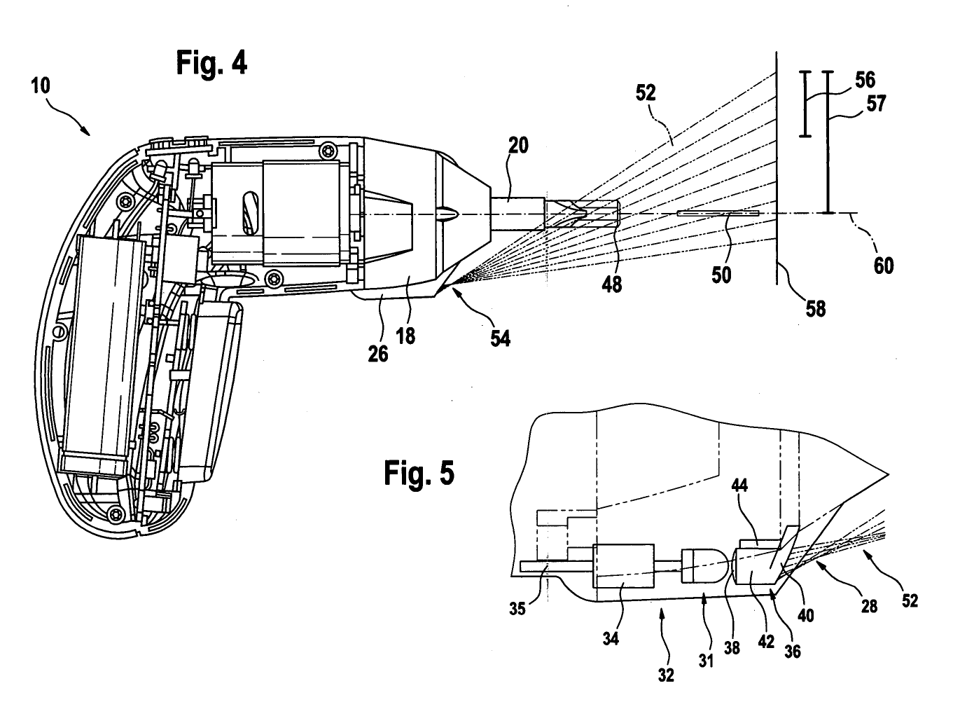

The power tool 10 shown in FIG. 1 is a cordless screwdriver, whose housing 12 has a pistol-type grip 14. Located in the interior of the grip 14 are a rechargeable battery 15 (FIG. 4) and an outward-protruding pushbutton 16, which serves to switch the motor 17 (FIG. 4) on and off. The motor 17 drives a driven shaft 20, which is supported in the gearbox 18 and protrudes from it toward the front side 22. The metal gearbox 18 is flanged, on the right in the viewing direction, to a plastic motor housing 19. In exemplary embodiments of the invention that are not shown, the gearbox may be of plastic.

An integrated light tube 26 is located on the underside 24 of the gearbox 18 and receives a lighting device 31; it is visible from outside as a semicylindrical contour parallel to the motor shaft 20, and it has a front opening 28, beveled toward the front, for a focused beam of light 22 to emerge from. Adjoining the light tube 26, a tubular transition piece 30 extends on the motor housing 19, and a power cord 35 for supplying power to a lighting device is guided in it for the sake of connection to the battery 15.

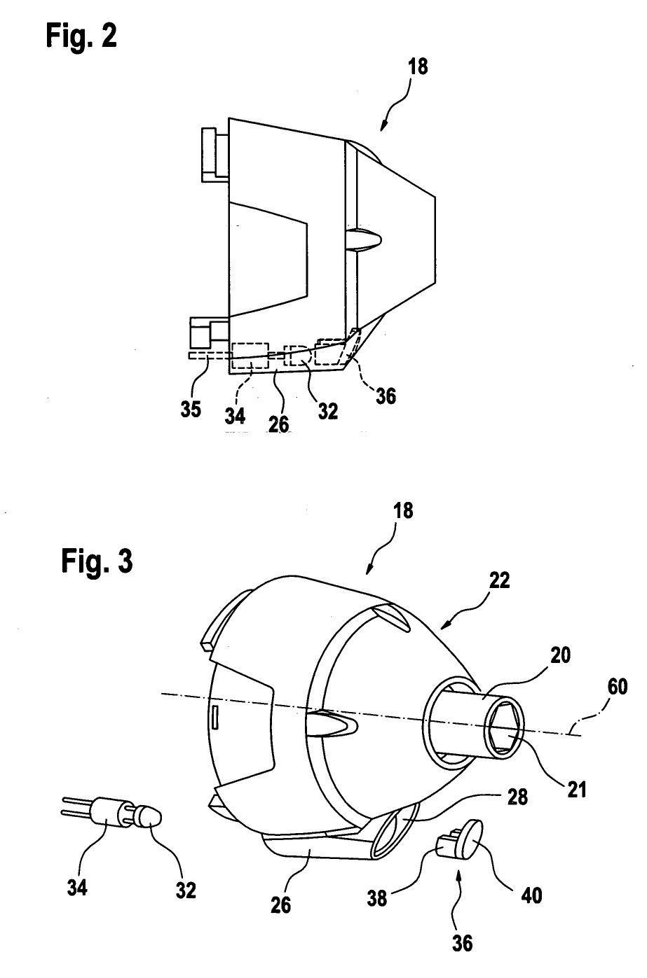

FIG. 2 shows a side view of the gearbox 18 as a detail, in which the light tube 26 can be seen on the underside 24, with the lighting device 31 drawn in dashed lines in the internal contour of the light tube. The lighting device comprises a light-emitting diode (LED) 32, which is seated on a base 34 that serves as an axial spacer and as a fitting piece for inserting and locking the LED 32 in the light tube 26. A one-piece light guide system 36, which corresponds to an elongated cylindrical biconvex lens is located at a defined axial spacing in front of the LED 32 in the light tube 26.

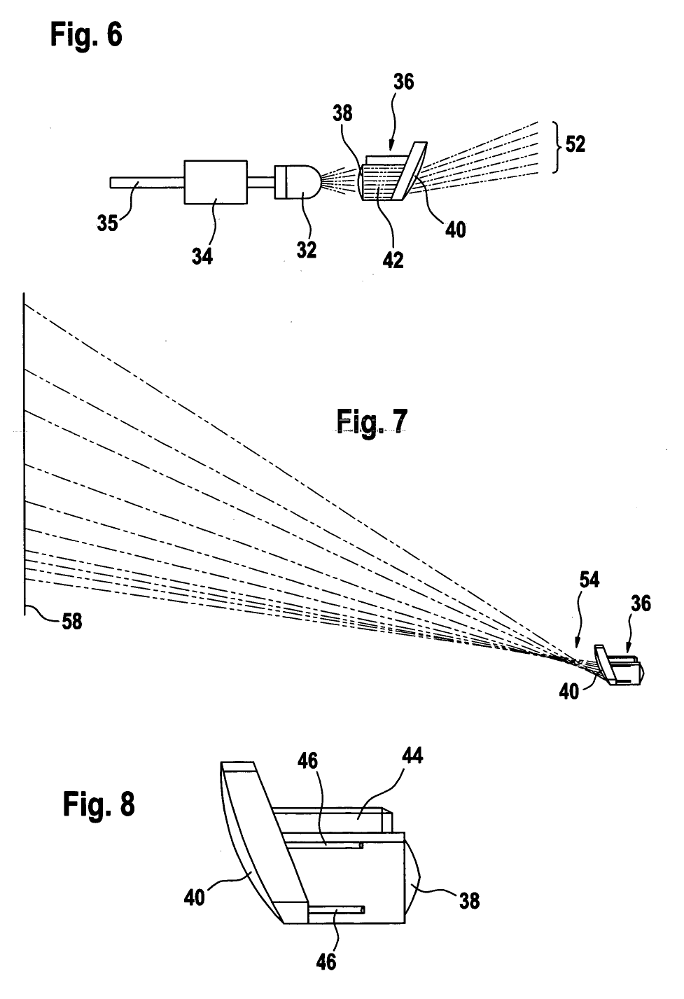

FIG. 3 shows a three-dimensional side view of the gearbox 18 and driven shaft 20 and with the lighting device 31 shown in exploded form. The design of the LED 32 and of the one-piece light guide system 36 with the rear lens and front lens 38, 40 (FIGS. 5, 6) is clearly apparent along with the front opening 28 of the light tube 26. It can also be seen that the driven shaft 20 is provided with a hexagonal socket 21, which serves to receive screwdriving or drill bits 48, 50 that have a hexonagonal shank.

The X-ray view of the power tool 10 shown in FIG. 4 shows, besides the details which have already been explained in conjunction with the previous drawings and will not be mentioned again here, a focused beam of light 52, which converges at the focal point 54 just in front of the front opening 28 or the front lens 40 and, diverging at that point, is projected obliquely upward and frontward onto the screwdriving or drill bits 48, 50 and onward onto a work field 58. The outlines of the screwdriving or drill bits 48, 50 are projected in the form of shadows 56, 57 onto the work field 58. The shadows 56, 57 are more sharply contoured and are projected closer to the axis 60 of the driven shaft 20, the closer the screwdriving or drill bit 48, 50 comes to the work field 58. These shadows 56, 57 act like mirror images of the tip of the screwdriving or drill bit 48, 50 and together with it act like a crosshair, which finally closes at the point where the tip meets the work field, since the tip of each bit 48, 50 touches the tip of the shadow 56, 57.

The shadow 56 of the screwdriving bit 48 located farther away from the work field 58 is projected onto the work field markedly farther above the axis 60 than the shadow 57 of the drill bit 50 located closer to the work field 58. Thus the closer the particular bit 48, 50, with its tip, approaches the work field, the closer to the axis 60 where the tip of the bit 48, 50 be projected.

FIG. 5 shows an enlarged detail of the region of the power tool 10 having the lighting device 31. Its individual parts are clearly recognizable by their shape and location relative to one another; besides the base 34, the LED 32 and the light guide system 36, one can see the power cord 35 and the embodiment of the cylinder 42 between the rear lens and front lens 38, 40, with the eccentric cylinder 44 located above the lenses for improving the light transfer from the rear lens 38 to the front lens 40, as well as the front opening 28, protruding past the front lens 40, of the light tube 26.

FIG. 6 shows the detail of the lighting device 31 of FIG. 4 schematically, with the LED 32 and the base 34 and the cord 35, along with the light guide system 36.

FIG. 7 shows a side view of the optical light guide system 36 with the beam path of the focused beam 52; the focal point 54 is located approximately 12 mm in front of the front lens 40, and the work field 58 is located approximately 100 mm in front of the front lens.

FIG. 8 shows an enlarged side view of the light guide system 36 of FIG. 7; the details of the rear lens 38, front lens 40, cylinder 42, and eccentric cylinder 44 are visible, along with longitudinally extending ribs 46, on both sides of the cylinder 44, for fitting the light guide system 36 into the light tube 26 and firmly holding it there.

It will be understood that each of the elements described above, or two or more together, may also find a useful application in other types of constructions differing from the types described above.

While the invention has been illustrated and described as embodied in a power tool with a work field illuminator, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A power tool, comprising a housing; a tool emerging from said housing; a lighting device provided for a work field and associated with said tool; said lighting device including a light source configured as an LED, and an optical light guide system located downstream of said light source and collecting light from said LED and also conducting the light and aiming it at the work field; a light tube provided on said housing and accommodating said LED and said light guide system.

2. A power tool as defined in claim 1, wherein said optical light guide system has curved end faces.

3. A power tool as defined in claim 1; and further comprising a current source; and a power cord located in an interior of said housing and connecting said light guide system to said current source.

4. A power tool as defined in claim 3, wherein said current source is configured as a rechargeable battery which is associated with said housing in a manner selected from the group consisting of being located in said housing and being located on said housing.

5. A power tool as defined in claim 3, wherein said current source is configured as a dynamo located in a manner selected from the group consisting of being located in said housing and being located on said housing.

6. A power tool as defined in claim 1, wherein said light guide system is in one piece and has a rear lens and a front lens.

7. A power tool as defined in claim 6, wherein said light guide system extends between said rear lens and said front lens as a cylinder that is concentric with said front lens and that on its top side has an eccentric parallel cylinder communicating with said LED for conducting light.

8. A power tool as defined in claim 1; and further comprising a gear box that forms a front region of said housing, said light tube being an integral part of said gear box.

9. A power tool as defined in claim 8, wherein said gear box is composed of metal.

10. A power tool as defined in claim 1, wherein said LED is located, positionally secured to a defined position relative to said light guide system, jointly with said light guide system, in said light tube.

11. A power tool as defined in claim 1, wherein said light tube is located on an underside of said housing.

12. A power tool as defined in claim 6, wherein, said light tube protrudes beveled, past said front lens and is configured as a guard for said front lens against damage from hitting things as the power tool is being manipulated and worked with.

13. A power tool as defined in claim 6, wherein said front lens when compared to said rear lens is inclined obliquely toward a front.

14. A power tool as defined in claim 6, wherein said front lens focusing light arriving from said LED and aiming it obliquely upward as a cone of light, so that said tool carried by the power tool is illuminated longitudinally.

15. A power tool as defined in claim 14, wherein said front lens aims the light obliquely upwards without intersecting a contour of a gear box that forms a front region of said housing.

16. A power tool as defined in claim 14, wherein said front lens aims the light obliquely upwards also in a region of a driven shaft protruding out of a gear box that forms a front region of said housing.

17. A power tool as defined in claim 6, wherein said front lens is configured so that two cones of light emerge from said front lens, with a lower cone of light forming a large-area light spot and an upper cone of light forming a small-area light spot located above the large-area light spot, said large-area light spot being formed by light guided in a concentric-cylindrical region, and said small-area light spot being formed by light conducted in an eccentric-cylindrical region.

18. A power tool as defined in claim 1, wherein the power tool is configured as a cordless power tool.
